(19) United States
(12) Patent Application Publication
(10) Pub. No.: US 2004/0007321 A1
(43) Pub. Date: Jan. 15, 2004

(54) Lamination systems and methods

(76) Inventors: Eric Urdahl, Eau Claire, WI (US); Mike Kittelson, Altoona, WI (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/194,544

(22) Filed: Jul. 11, 2002

(51) Int. Cl. B29C 65/00; C09J 5/00

(52) U.S. Cl. 156/285; 156/323; 29/830; 29/846; 29/829

(57) ABSTRACT

The present invention is directed to lamination systems and methods, whereby a stack of members to be laminated is protected from the mats of the platens used to apply heat and pressure to the stack during lamination, by one or more interposer layers positioned between the stack and the platens and possibly bound to the stack.

### FIELD OF THE INVENTION

The field of the invention is lamination.

### BACKGROUND OF THE INVENTION

Multi-layer laminates such as interconnects and printed wiring board are sometimes damaged during the lamination process. Such damage may result in problems in subsequent processing such as circuit traces that become “shorted together” during electrolytic copper plating. Laminates with such problems must typically be either repaired or scrapped. As such, there is a continuing need for improved lamination systems and processes.

### SUMMARY OF THE INVENTION

The present invention is directed to lamination systems and methods, whereby a stack of members to be laminated is protected from the mats of the platens used to apply heat and pressure to the stack during lamination, by one or more interposer layers positioned between the stack and the platens.

In one aspect of the invention, copper clad laminates are used as interposers to protect outside surfaces for a stack to be laminated from being embossed or otherwise damaged by the mats of the platens used to apply heat and pressure to the stack.

In another aspect, the interposers are sufficiently thin and have a heat transfer capacity sufficiently large so as to allow the interposers to be used between a platen and a stack without preventing heat from the platen to be transferred into the stack.

In yet another aspect, the interposers are sufficiently thick and/or rigid so as to prevent patterns on a platen from being transferred through the interposer to the stack.

In still another aspect, a stack is bound in a manner similar to binding a book by positioning the stack between two covers/interposers, and binding the covers and the stack members together by an adhesive binding positioned along one side/edge of the stack.

The systems and methods described herein are particularly applicable when vacuum laminating dry film build up materials. During such lamination using prior art devices a methods, a weave pattern from the platen mats of the vacuum laminator can transfer onto the build-up material causing an uneven, or woven, topography on the surface of the built-up layer. Because of the “weave” topography, the photoimageable dry film used to define the circuit pattern is unable to conform completely to the substrate surface. This condition results in circuit traces that become “shorted” together during the electrolytic copper plating process and must either be repaired or scrapped. The methods and devices described herein solve the problem by placing the panel to be vacuum laminated with a dry film build-up material between two pieces of clean, un-etched copper core material (one piece on the top and one piece on the bottom) to create a “sandwich”. One edge of the assembly is then secured using plating tape to prevent any of the layers from shifting, while still allowing the materials to flow during the compression stage of the vacuum lamination process.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a side view of a lamination system embodying the invention;

FIG. 2 is an exploded side view of the stack, covers, and bindings of FIG. 1.

### DETAILED DESCRIPTION

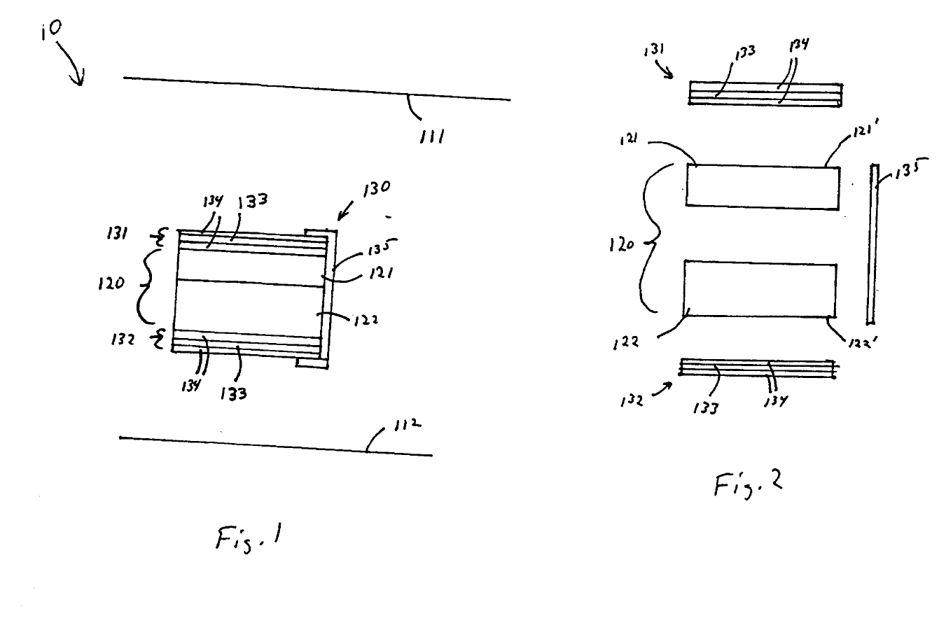

A method of laminating a stack of members together comprises providing a stack of members to be laminated; sandwiching the stack of members between two interposers to form a protected stack; positioning the protected stack between two platens; and using the platens to apply heat and pressure to the protected stack to laminate the members of the stack together. The system of FIGS. 1 and 2 can be used to implement this method.

In FIGS. 1 and 2, a lamination system 10 comprises first and second platen mats 111 and 112, a stack to be laminated 120, and binding and protection system (“BPS”) 130. BPS 130 comprises interposers 131 and 132, and binding member 135. Interposers 131 and 132 each comprise a dielectric layer 133 sandwiched between metal layers 134. In preferred embodiments interposers 131 and 132 are copper clad laminates with layers 134 being copper layers.

It is important that the surfaces of interposers 131 and 132 that are placed in contact with surfaces 121′ and 122′ of stack members 121 and 122 be smoother than the surfaces of platen mats 111 and 112 in order to eliminate transferring any roughness or pattern of the mats onto surfaces 121′ and 122′. It is also important that the interposers 131 and 132 are sufficiently thin and have a heat transfer capacity sufficiently large so as to allow the interposers 131 and 132 to be used between platens 111 and/or 112 and stack 120 without preventing heat from the platens to be transferred into the stack.

A preferred interposer is a clean, un-etched copper core comprising a 4 mil dielectric core sandwiched between two 0.5 mil thick copper layers. Such a metal clad laminate is contemplated to provide a favorable compromise between factors such as minimum thickness, heat transfer, cost, and availability. Slightly less preferred interposers comprise 0.35 mil or 0.7 mil copper layers. Other less preferred interposers may utilize metals other than copper, cores and metal layers having different thicknesses, and/or different structures such: as a single layer of either metal or dielectric material; a single layer each of metal and dielectric; or more than 3 metal and/or dielectric layers. The preferred interposer will preferably be subjected to a cleaning process prior to use to minimize the risk of transferring impurities to the stack and/or causing surface blemishes.

In addition to sandwiching the stack between interposers, it is preferred that the entire package (interposers and stack) be secured along one edge using a binding member such as a heat resistant plating tape. If the entire edge is not to be bound, it is preferred that the edge be bound in at least two places. In some instances the package will be slid or otherwise moved between platens with one edge being the leading edge during such movement. In such cases it is preferred that the bound edge be the leading edge (i.e. the first edge to be moved between the platens). In less preferred embodiments, less than all of the stack members may be bound, and/or one or none of the interposers may be bound.

Members 121 and 122 of stack 120 may comprise any combination of materials. However, it is contemplated that the methods and devices described herein will be particularly advantageous when stack 120 comprises a plurality of dielectric and conductive layers, with some of the conductive layers forming electrical circuits. It is contemplated that the devices and methods described herein may be most advantageously used when stack 120 comprises dry film build up materials.

The actual materials and structure of platens and platen mats used are not critical. In many embodiments, mats 111 and 112 will each be made of rubber or other material coupled to a platen adapted to apply heat and pressure to a stack to be laminated.

Thus, specific embodiments and applications of lamination systems and methods have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A lamination system comprising:
a first platen mat;
a stack to be laminated; and
a first interposer positioned between the first platen mat and the stack to be laminated, the first interposer having a surface adjacent the stack to be laminated that is smoother than the surface of the first platen mat adjacent to the first interposer.

2. The system of claim 1 further comprising a second platen mat and a second interposer;
wherein the stack is positioned between the first platen mat and the second platen mat;
the second interposer is positioned between the second platen mat and the stack; and the second interposer has a surface adjacent the stack that is smoother than the surface of the second platen mat adjacent to the second interposer.

3. The system of claim 2 wherein the stack comprises at least two members, the system further comprising a binding member binding the at least two stack members together.

4. The system of claim 3 wherein the binding member binds the at least two stack members to the first and second interposers.

5. The system of claim 4 wherein at least one interposer comprises a metal layer.

6. The system of claim 5 wherein the at least one interposer comprises a metal clad laminate having a dielectric core sandwiched between two metal layers.

7. The system of claim 6 wherein the metal clad laminate comprises a 4 mil core sandwiched between two copper layers.

8. The system of claim 7 wherein the two copper layers have a thickness of 0.35, 0.5, or 0.7 mils, and the binding member comprises a piece of plating tape coupled to one side of the stack.

9. The system of claim 8 wherein the two copper layers are un-etched and clean.

10. A method of laminating a stack of members together comprising:
providing a stack of members;
sandwiching the stack of members between two interposers to form a protected stack;
positioning the protected stack between two platens;
using the platens to apply heat and pressure to the protected stack to laminate the members of the stack together.

11. The method of claim 10 further comprising binding the stack members to the interposers.

12. The method of claim 11 wherein binding the stack members comprises applying tape to one edge of the stack.

13. The method of claim 12 wherein positioning the stack between two platens comprises sliding the stack between the platens, with the bound edge of the stack as the leading edge.
